(19) United States
(12) Patent Application Publication
(10) Pub. No.: US 2023/0153963 A1
(43) Pub. Date: May 18, 2023

(54) ONLINE MEETING NON-PARTICIPANT DETECTION AND REMEDIATION

(71) Applicant: Citrix Systems, Inc., Fort Lauderdale, FL (US)

(72) Inventors: Cheng Zhang, Nanjing (CN); Yunxiang Wang, Nanjing (CN); Bo Chen, Nanjing (CN); Zhipan Liu, Nanjing (CN)

(21) Appl. No.: 17/646,017

(22) Filed: Dec. 27, 2021

Related U.S. Application Data
(63) Continuation of application No. PCT/CN2021/131493, filed on Nov. 18, 2021.

(51) Int. Cl. G06T 5/00; G06V 40/10; H04N 5/232; H04N 5/262; H04L 65/1089

(52) U.S. Cl. CPC G06T 5/005; G06V 40/10; H04N 5/23229; H04N 5/262; H04L 65/1089; G06T 2207/30196; G06T 2207/10016

(57) ABSTRACT

According to some embodiments, a method includes: receiving, by a computing device associated with a user, a video stream captured by a camera; detecting, by the computing device, persons appearing within a field of view of the camera based on analysis of the video stream; and in response to a determination that one or more persons other than the user appear within the field of view of the camera, providing, by the computing device, a modified video stream in which the one or more persons other than the user do not appear during display of the modified video stream.

### CROSS REFERENCE TO RELATED APPLICATIONS

This application is a continuation of and claims the benefit of PCT Patent Application No. PCT/CN2021/131493 filed on Nov. 18, 2021 in the English language in the State Intellectual Property Office and designating the United States, the contents of which are hereby incorporated herein by reference in its entirety.

Organizations schedule meetings for a variety of reasons. For example, within a company, employees may participate in (e.g., attend) monthly planning meetings, weekly status meetings, etc. Online or “virtual” meetings are an increasingly popular way for people to collaborate, particularly when they are in different physical locations. Online meeting services, such as TEAMS, ZOOM, and GOTOMEETING, may provide audio and video conferencing among other features. In the case of video conferencing, a user may permit an online meeting application installed on their client device to access a video camera connected to, or otherwise associated with, the client device. Using the video camera, the online meeting application may capture and share a video stream that includes images of the user and/or any other person appearing within the camera's field of view.

### SUMMARY

With the rise in work-from-home, hybrid, other flexible working arrangements, it is increasingly common for employees to participate in online meetings from their homes, from shared offices, or even from cafes or other public spaces. This can result in a loss of privacy as other persons within the same physical environment (e.g., family members, colleagues, members of the public, or other person not participating in the meeting) may appear within a shared video stream without their knowledge or consent. Having non-meeting-participants appear within the shared video stream may also be distracting to the meeting's participants. Some online meeting services allow a user to apply a virtual background which hides certain portions of the user's physical environment within the shared video stream. However, using a virtual background does not address the aforementioned privacy issue because other persons within the camera's field of view may still appear in the shared video stream. Embodiments of the present disclosure can enhance, among other aspects, the privacy of online meetings by using image recognition (e.g., facial recognition) to automatically prevent persons not participating a meeting from appearing within a shared video stream.

According to one aspect of the disclosure, a method may include: receiving, by a computing device associated with a user, a video stream captured by a camera; detecting, by the computing device, persons appearing within a field of view of the camera based on analysis of the video stream; and in response to a determination that one or more persons other than the user appear within the field of view of the camera, providing, by the computing device, a modified video stream in which the one or more persons other than the user do not appear during display of the modified video stream.

In some embodiments, the providing of the modified video stream may include removing appearances of the one or more persons other than the user from the video stream or from a copy of the video stream. In some embodiments, the providing of the modified video stream can include obfuscating appearances of the one or more persons other than the user within the video stream or within a copy of the video stream. In some embodiments, the providing of the modified video stream may include generating another video stream.

In some embodiments, the method can further include: receiving, by the computing device, data representative of the user's appearance, wherein the determination that the one or more persons other than the user appear within the field of view of the camera can be based on the data representative of the user's appearance. In some embodiments, the receiving of the data representative of the user's appearance may include receiving an image of the user. In some embodiments, the image of the user may be received from an application running on another computing device. In some embodiments, the receiving of the data representative of the user's appearance may include receiving an image selected by the user.

In some embodiments, wherein the video stream is received from a first client device, the method can also include transmitting, by the computing device, the modified video stream to a second client device. In some embodiments, wherein the camera is in communication with the computing device, the method can further include transmitting, by the computing device, the modified video stream to another computing device.

According to one aspect of the disclosure, a computing device can include a processor and a non-volatile memory storing computer program code that when executed on the processor causes the processor to execute a process that is the same as or similar to any of the methods described above.

According to one aspect of the disclosure, a non-transitory machine-readable medium encoding instructions that when executed by one or more processors can cause a process to be carried out, the process being the same as or similar to any of the methods described above.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4A illustrates a physical environment in which an online meeting may be attended.

FIG. 4B illustrates a video stream that may be provided by an online meeting application for a meeting attended within the physical environment of FIG. 4A.

FIGS. 4C-4E illustrate video streams that may be provided according to embodiments of the present disclosure for a meeting attended within the physical environment of FIG. 4A.

FIG. 5 is a diagram of an illustrative network in which image recognition can be used to conduct online meetings, according to some embodiments.

FIG. 6 is a diagram of an illustrative client that can use image recognition for online meetings, according to some embodiments.

FIGS. 7A-7D show an illustrative user interface (UI) that can be provided within the client of FIG. 6, according to some embodiments.

FIGS. 8, 8A, and 8B are flow diagrams of illustrative processes for performance of online meetings using image recognition, according to some embodiments.

The drawings are not necessarily to scale, or inclusive of all elements of a system, emphasis instead generally being placed upon illustrating the concepts, structures, and techniques sought to be protected herein.

### DETAILED DESCRIPTION

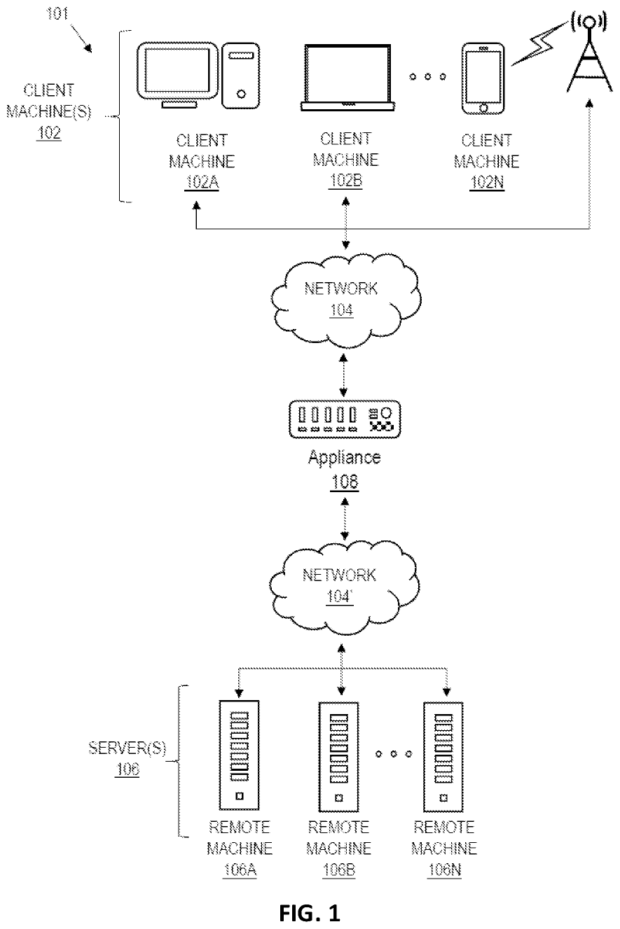

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

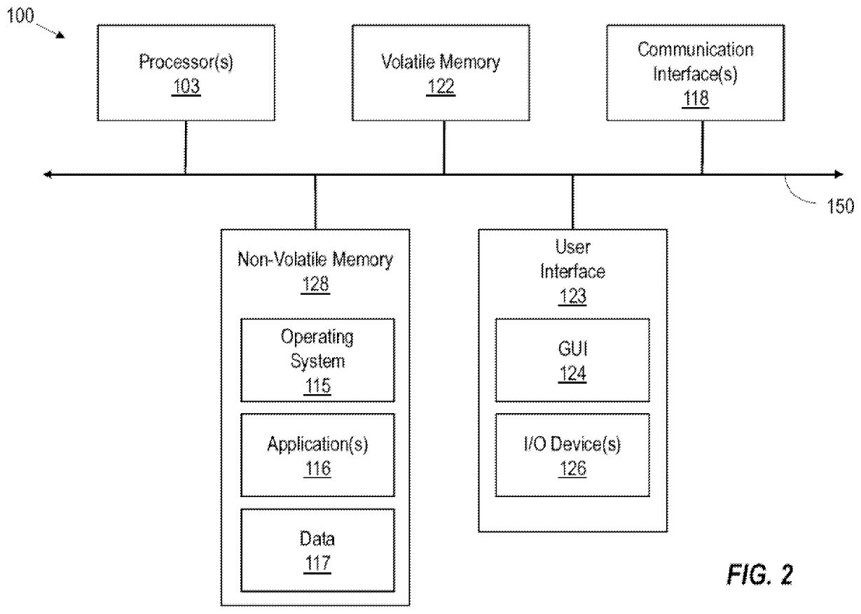

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more loudspeakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

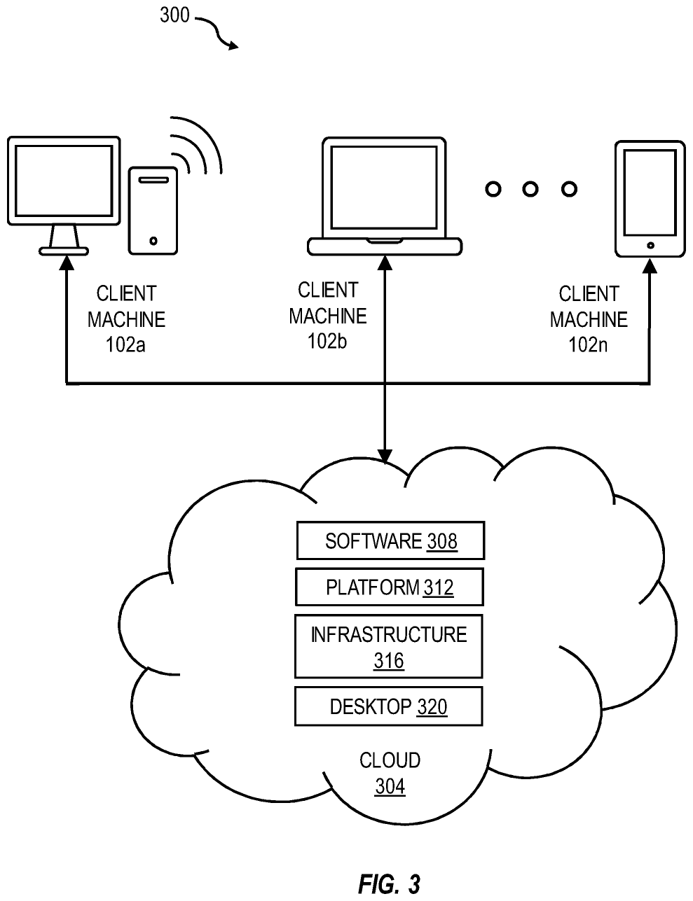

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

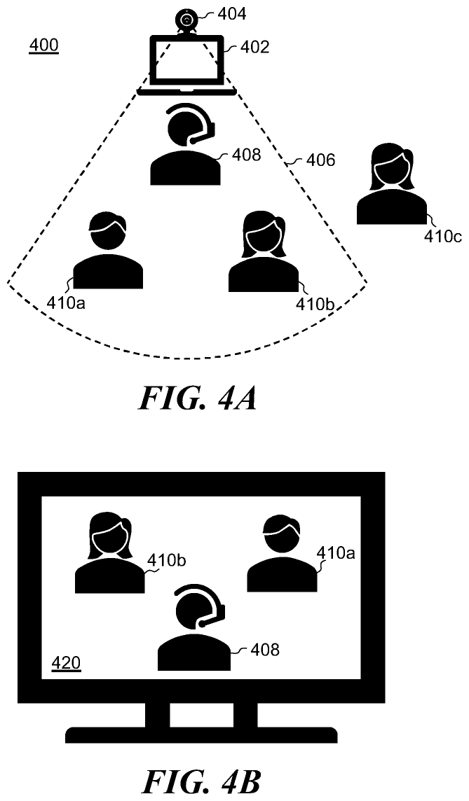

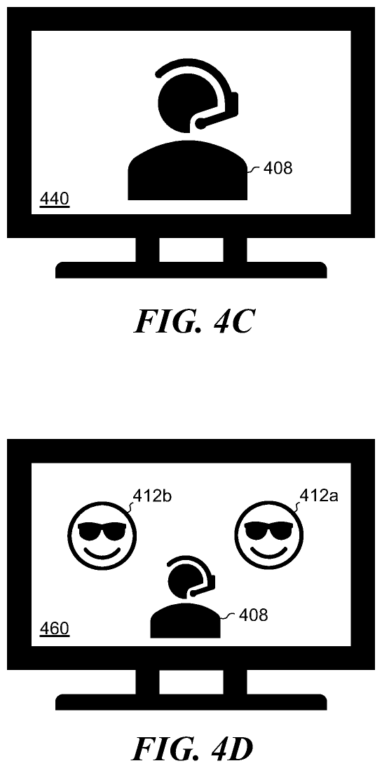

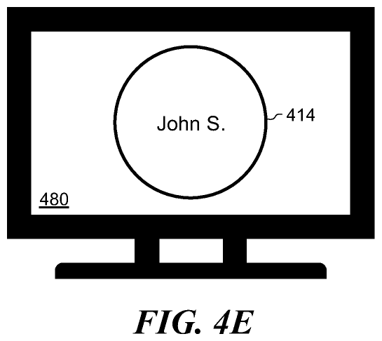

FIG. 4A shows an example of a physical environment 400 in which an online meeting may be attended. Physical environment 400 may correspond to, for example, a home office, a shared office space, a cafe, etc. A client 402 includes or otherwise has access to a camera 404 (e.g., a video camera) having a field of view 406. A user 408 may use client 402 to participate in (e.g., attend) an online meeting with one or more other users (e.g., users of remote clients). The user 408 may orient the camera 404 such that user 408 is within the camera's field of view 406. One or more other persons 410a, 410b, 410c that are not participating in the online meeting may be present within the same physical environment 400 as user 408. The other persons 410a, 410b, 410c (410 generally) may correspond to, for example, family members or co-workers that happen to be in the same physical environment 400 as user 408. Depending on the orientation of the camera 404 and the location of the other persons 410 within the physical environment 400, one or more of the other persons 410 may appear at least partially within the camera's field of view 406. In the example of FIG. 4A, two other persons 410a, 410b are within the camera's field of view 406, whereas a third other person 410c is outside the field of view 406.

FIG. 4B shows an example of a video stream 420 that may be provided by (e.g., generated by) an online meeting application running on client 402 of FIG. 4A. The video stream 420 may be captured by client 402 of FIG. 4A and shared with (e.g., transmitted to) one or more other clients used by other meeting participants. The one or more other clients may display the video stream 420 on a monitor or other display device, such as illustrated in FIG. 4B. With some meeting applications, user 408 and other persons 410a, 410b may all appear within the provided video stream 420. This may be an invasion of the other people's 410a, 410b privacy and/or distraction to the meeting participants.

Turning FIGS. 4C-4E, embodiments of the present disclosure can use image recognition to identify a user appearing within a video stream and to modify an existing video stream to remove, replace, obfuscate, or otherwise filter out appearances of other persons such that the other persons do appear when the modified video stream is displayed. In some embodiments, the modified video stream may correspond to another video stream that is generated by, for example, copying and then modifying an existing video stream. That is, a “modified video stream” according to the present disclosure may correspond to either a modification of an existing video stream or to another video stream that is generated based on the existing video stream. In some embodiments, the modified video stream may be transmitted to client devices of other meeting participants instead of the captured video stream. In some embodiments, the modified video stream may be displayed by the client that performed the modification (e.g., in addition to, or in place of, transmitting the modified video stream to other clients).

In the example of FIG. 4C, a video stream 440 may be provided in which user 408 appears and the appearances other persons 410a, 410b are removed. As shown in FIG. 4C, in some embodiments, the video stream may be cropped or otherwise modified after the other persons 410a, 410b are removed to adjust an appearance of user 408. For example, such an adjustment may cause user 408 to appear larger within a display of the modified video stream.

In the example of FIG. 4D, a video stream 460 may be provided in which user 408 appears and the appearances of other persons 410a, 410b are replaced by images 412a, 412b that generally do not resemble other persons 410a, 410b. For example, images 412a, 412b may include a graphics that represent a presence of a person without showing a person's face. In short, the graphics can hide the identity of person while also indicating the person's presence. In some embodiments, the appearances of other persons 410a, 410b may be blurred, distorted, or otherwise obfuscated within the modified video stream.

In the example of FIG. 4E, in response to detecting one or more other persons within the camera's field of view, a video stream 480 may be provided in which the appearances of all persons—including user 408 and other persons 410a, 410b—are replaced by an image 414 (e.g., a static image showing an icon representation of user 408).

In some embodiments, if another person is detected in front of a user such that the user is partially blocked from appearing within the camera's field of view, the appearances of both the user and the other person may be filtered out of or otherwise replaced within the modified video stream.

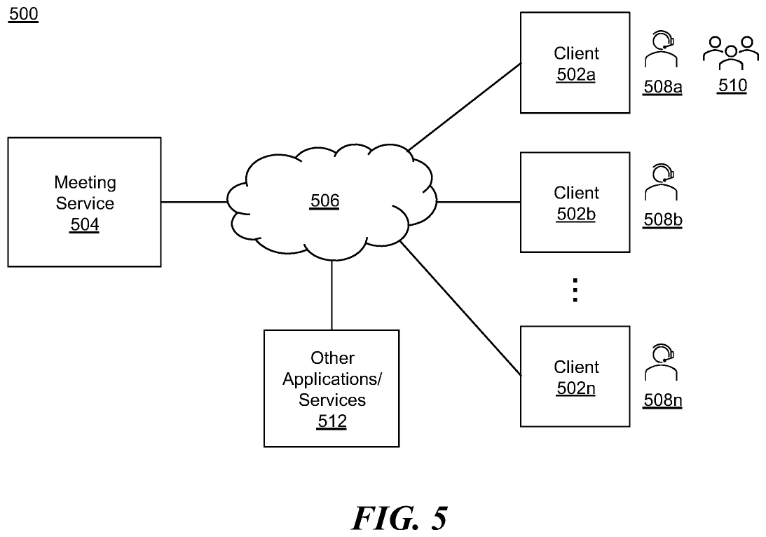

FIG. 5 shows an example of a network environment within which image recognition can be used to conduct online meetings, according to embodiments of the present disclosure. An illustrative network environment 500 includes a plurality of clients 502a, 502b, . . . , 502n (502 generally) and an online meeting service (or “meeting service”) 504. Clients 502 may be configured to communicate with the meeting service 504 via one or more computer networks 506 (e.g., via the Internet).

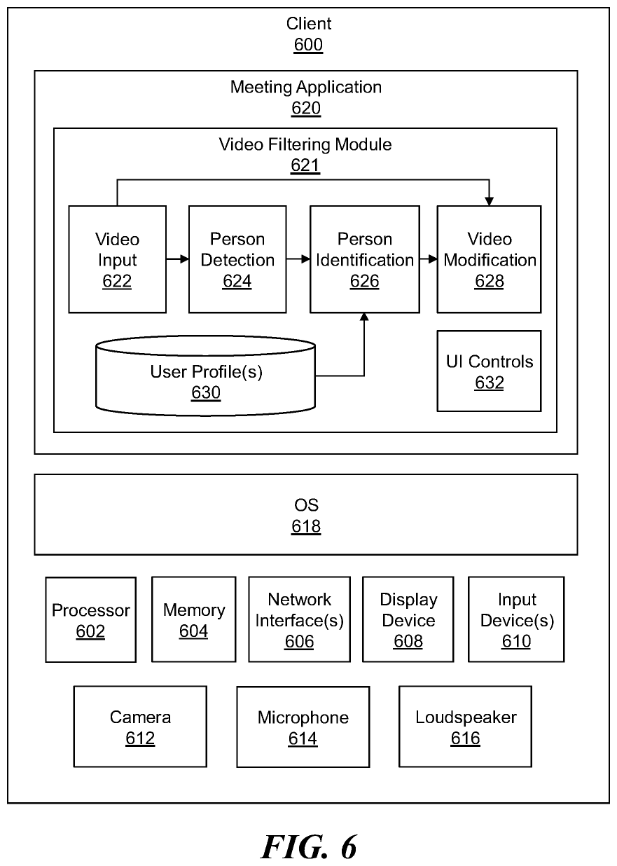

Clients 502a, 502b, . . . , 502n may be used by or otherwise associated with users 508a, 508b, . . . , 508n (508 generally), respectively. Users 508 may correspond to participants of an online meeting hosted by online meeting service 504. Clients 502 can include, for example, desktop computing devices, laptop computing devices, tablet computing devices, and/or mobile computing devices. Clients 502 can be configured to run one or more applications, such as desktop applications, mobile applications, and SaaS applications. Among various other types of applications, clients 502 can run an online meeting application (or “meeting application”) that provides audio and video conferencing among other features. For example, clients 502 can run TEAMS, SKYPE, ZOOM, GOTOMEETING, WEBEX, or another meeting application. The meeting application running on clients 502 can communicate with meeting service 504 and/or with the meeting applications running on other clients 502 (e.g., using peer-to-peer communication). An example of a client that may be the same as or similar to any of clients 502 is described below in the context of FIG. 6. In some embodiments, a client 502 may be the same or similar to a client machine 102A-102N of FIG. 1 and/or FIG. 3.

A first user 508 may use a first client 502a to participate in an online meeting with one or more other users 508b, . . . , 508n using one or more other clients 502b, . . . , 502n. During the meeting, client 502a may receive a video stream captured by a camera connected to, or otherwise associated with, client 502a. The video stream may show (i.e., include an appearance of) the first user 508a along with other persons 510 that happen to be within the camera's field of view, including persons that may not be participating in the meeting. Client 502a can analyze the captured video stream to detect the persons appearing within the camera's field of view, and then modify the captured video stream or generate another video stream in which the other persons 510 do not appear (e.g., are removed, replaced, obfuscated, or otherwise filtered out). The modified video stream can then be transmitted to (e.g., shared with) and displayed by the one or more other clients 502b, . . . , 502n. For example, client 502a may transmit the modified video stream to meeting service 504 via networks 506 and, in turn, meeting service 504 may transmit the modified video stream (or a processed version thereof) to the other clients 502b, 502n. As another example, client 502a may transmit the modified video stream directly to the other clients 502b, . . . , 502n.

In some embodiments, client 520a may transmit the captured (i.e., the existing or unmodified) video stream to other clients 502b, . . . , 502n which, upon receipt thereof, can analyze the captured video stream to detect the persons appearing within the camera's field of view, and then modify the captured video stream or generate another in which the other persons 510 do not appear. That is, the image recognition and video filtering techniques disclosed herein may be utilized within the client that captures a video stream (e.g., client 502a) and/or within other clients that receive the captured video stream (e.g., clients 502b, . . . , 502n). This may be done, for example, to reduce bandwidth usage in the case where the modified video stream uses more bandwidth the captured/existing/unmodified video stream.

In some embodiments, a client 502 may store or otherwise have access to profiles of one or more of the users 508. A user profile can include data representative of the appearance of a user along with various other information about the user or the user's preferences. The data representative of the user's appearance may include a digital image of the user and, in some cases, a digital image that shows the user's face. Such a digital image may be referred to as a “profile image.” Various applications and devices may allow, or even require, a user to upload or otherwise select a profile image. For example, operating systems (OS's) such as WINDOWS and MACOS allow a user to select a profile image. As another example, applications such as TEAMS, ZOOM, GOTOMEETING, SLACK, BASECAMP, TWITTER, FACEBOOK, INSTAGRAM, LINKEDIN, OUTLOOK, and many other applications allow a user to select a profile image. In some embodiments, a client 502 may be configured to access one or more user profile images from meeting service 504 and/or from other applications/services 512. The other applications/services 512 can generally include any applications/services that enable a user to select a profile image including but not limited to the aforementioned examples. In some embodiments, a client 502 can retrieve one or more user profile images from meeting service 504 and/or from another applications/services 512 using an API provided thereby. A client 502 can use the one or more user profile images to identify one or more users (e.g., meeting participants) appearing within a video stream and, by implication, to identify persons other than the one or more users appearing with the video stream.

FIG. 6 shows an illustrative client 600 that can be used within the network environment of FIG. 5. For example, client 600 can correspond to any or all of clients 502 of FIG. 5. The illustrative client 600 can include a processor 602, a memory 604, one or more network interfaces 606, a display device 608, one or more input devices 610, a camera 612, a microphone 614, and a loudspeaker 616. Memory 604 can store executable instructions for an operating system (OS) and one or more applications, and processor 602 can be configured to execute/run the OS and applications using the stored executable instructions. Display device 608 may be provided, for example, as a monitor or a touchscreen device. Input devices 610 may include, for example, a mouse, a touchpad, a touchscreen, or a stylus. Camera 612 can include a webcam or other type of camera capable of capturing video in real time, including video of persons with the camera's field of view. Microphone 614 can include to any device that converts sound (e.g., speech) into an audio signal and loudspeaker 616 can include any device that converts an audio signal into a corresponding sound. In some embodiments, microphone 614 and loudspeaker 616 may be collectively provided as a headset or as headphones. Display device 608, input devices 610, camera 612, microphone 614, and/or loudspeaker 616 can be included as parts of the client 600 or can otherwise be connected to or accessible thereby.

Client 600 can further include an operating system (OS) 618 and an online meeting application 620 (or “meeting application”) among various other applications. Meeting application 620 may correspond to TEAMS, SKYPE, ZOOM, GOTOMEETING, WEBEX, or another application that can provide video conferencing. Meeting application 620 may connect to an online meeting service (e.g., meeting service 504 of FIG. 5) via one or more computer networks (e.g., networks 506 of FIG. 5) to join online meetings hosted thereby.

Client 600 may be associated with one or more users. For example, OS 618 may allow for one or more user profiles to be created on, or otherwise associated with, client 600 and may provide a mechanism by which a user can authenticate themselves with client 600. A user that is actively using client 600 and/or that is presently authenticated with client 600 may be referred to as the “current user” of the client.

Client 600 can further include a video filtering module 621 configured to conduct online meetings by automatically filtering out appearances of certain persons (e.g., persons other than the current user of client 600) within a video stream captured by a camera. Video filtering module 621 can include various submodules such as a video input submodule 622, a person detection submodule 624, a person identification submodule 626, and a video modification submodule 628.

Video filtering module 621 may also include or otherwise have access to one or more user profiles 630. The user profiles 630 can include, among other information, profile images or other data representative of appearances of users of client 600. As previously discussed, such profile images may be obtained from an OS (e.g., OS 618) or from one or more applications accessible by client 600. In some embodiments, user profiles 630 may be stored/cached in a memory of client 600, such as in RAM, on disk, or in a database provided within client 600.

Video input submodule 622 can receive, as input, a video stream captured by camera 612. The video stream may include appearances of persons within the field of view of the camera, such as the current user and one or more other persons. In some embodiments, video input submodule 622 may store the received video stream in memory (e.g., in RAM) where it can be subsequently accessed by submodules 624, 626, and/or 628. In some embodiments, video input submodule 622 can receive a video captured by another client (e.g., a remote client) and transmitted to client 600 via one or more networks (e.g., networks 506 of FIG. 5).

Person detection submodule 624 can analyze the captured video stream to detect the presence and position of any persons appearing within the video stream (i.e., within the field of view of camera 612). For example, referring to the example of FIG. 4B, person detection submodule 624 can detect the presence and position of user 408 and other persons 410a, 410b appearing within video stream 420, as will described in more detail below.

A video stream can be composed of a sequence of images (“frames”) that can be displayed at a particular rate (“frame rate”). Within a video stream, individual frames may be uniquely identified by a value (“frame number”). Person detection submodule 624 can analyze individual frames or groups of frames within a video stream detect the presence and position of any persons appearing therein (e.g., the position of human bodies and/or faces appearing in the video stream). The position of a person appearing within a frame may be expressed as a plurality of points (e.g., x and y coordinates) that define an outline of the person, such as points defining a rectangle (“bounding box”) or other type of polygon. In some embodiments, the position of a person appearing within the video stream may be expressed as a range of frame numbers along with a plurality of points that defines an approximate/average outline of the person across those frames.

In some embodiments, person detection submodule 624 may use machine learning (ML)-based object detection technique to detect the positions of persons appearing with the video stream and/or particular frames thereof. For example, person detection submodule 624 may use a convolutional neural network (CNN) trained to detect the appearances of human bodies, human faces, etc. within images.

Person detection submodule 624 may extract image data from video stream at positions where a person's appearance is detected and may provide the extracted image data as output along with the corresponding position information. For example, for individual persons appearing in the video stream, person detection submodule 624 may output a data structure representing the image data extracted for that person along with the position within the video stream where the image data was extracted from.

Person identification submodule 626 can process the output of person detection submodule 624 to identify the current user (or, in some cases, one or more meeting participants) appearing in the video stream and to identify one or more other persons that may also appear in the video stream. In some embodiments, person identification submodule 626 can use one or more image recognition techniques (e.g., facial recognition and/or other types of biometric reignition) to probabilistically match an image of the current user to images of persons detected by person detection submodule 624. In more detail, person identification submodule 626 may retrieve an image of the current user from among the user profiles 630 and provide an image of the current user, along with images of all persons detected by person detection submodule 624 (the “candidate images”), as input to an image recognition system/application. The image recognition system/application may determine (e.g., using facial recognition techniques) which of the candidate images most closely matches the image of the current user and, by implication, which of the candidate images most likely correspond to persons other than the current user. In some embodiments, person identification submodule 626 may iteratively compare the images of persons detected by person detection submodule 624 to the image of the current user to determine which image most closely resembles the current user.

In some embodiments, video filtering module 621 can interface with OS 618 to determine the current user of client 600 and to select, from among one or more user profiles 630, the current user's profile image to be matched by person identification submodule 626. In some embodiments, the user can select an image of themselves appearing on screen using UI controls 632 (discussed further below) and the selected image may be matched by person identification submodule 626. Person identification submodule 626 can output information identifying the position of the current user appearing within the video stream and, separately, the positions of any other persons appearing within the video stream.

Video modification submodule 628 can use the output of person identification submodule 626, along with the video stream output by video input submodule 622, to modify the video stream or generate another in which the one or more persons other than the current user do not appear (i.e., do not appear when the video stream is played back or otherwise displayed). In some embodiments, video modification submodule 628 may generate a copy of the captured video stream and modify particular frames/positions within the copied video stream where the other persons appear such that the other persons do not appear in the modified video stream. In other embodiments, video modification submodule 628 may directly operate on the captured video stream to modify particular frames/positions within the copied video stream where the other persons appear such that the other persons do not appear in the modified video stream. For example, as illustrated in FIG. 4C, the appearances of the other persons may be removed from the modified video stream. As another example, as illustrated in FIG. 4D, the appearances of the other persons may be replaced by images that generally do not resemble other persons. In some cases, if one or more persons other than the current user are identified within the video stream, video modification submodule 628 may generate/modify a video stream in which the appearances of all persons, including the current user, are replaced by an image (e.g., a static image), such as illustrated in FIG. 4E. The video stream generated/modified by submodule 628 may then be shared with other clients devices (e.g., devices associated with the other meeting participants) in place of the video stream captured by camera 612.

In some embodiments, video filter module 621 may include a toggle switch, a checkbox, radio button, or other type of UI control 632 for selectively enabling the filtering of other persons from appearing in the shared video stream as discussed further below. If filtering is disabled, the video filter module 621 may directly output the video stream captured by camera 612.

As shown in FIG. 6, video filtering module 621 may be provided as part of meeting application 620. For example, video filtering module 621 may be provided as library or as a plugin/extension of meeting application 620. In other embodiments, video filtering module 621 may be provided as a standalone application or service that interfaces with meeting application 620 to perform the attributed functionality described herein. For example, video filtering module 621 may send/receive data (e.g., video stream data) to/from meeting application 620 using inter-process communication (IPC) and/or by operating on files (e.g., video files) generated by meeting application 620. In still other embodiments, the disclosed structure and/or functionality of video filtering module 621 may be implemented in whole or in part on a server device. For example, the structure/functionality of video filtering module 621 may be implemented as part of an online meeting service (e.g., meeting service 504 of FIG. 5) and/or within a cloud network (e.g., within cloud network 304 of FIG. 3). In more detail, client 600 may transmit a video stream captured by camera 612 to a server device and the server device may perform the operations of submodules 624, 626, and 628 to provide a modified video stream in which certain persons do not appear. The server device may then transmit the modified video to one or more other clients for display.

While some embodiments of the present disclosure are described as providing a modified video stream in which only a single person (e.g., the current user) appears while all other persons are filtered out, the structures and techniques disclosed herein can also be applied to provide a modified video stream in which multiple persons (e.g., the current user and one or more other persons) appear while other persons are filtered out. For example, using UI controls 632, the user may select an image of themselves and one or more other persons appearing on screen using and person identification submodule 626 can match against each of the selected images. As another example, client 600 may retrieve images of multiple users participant in an online meeting from an online meeting service (e.g., online meeting service 504 of FIG. 5) or from another application or service.

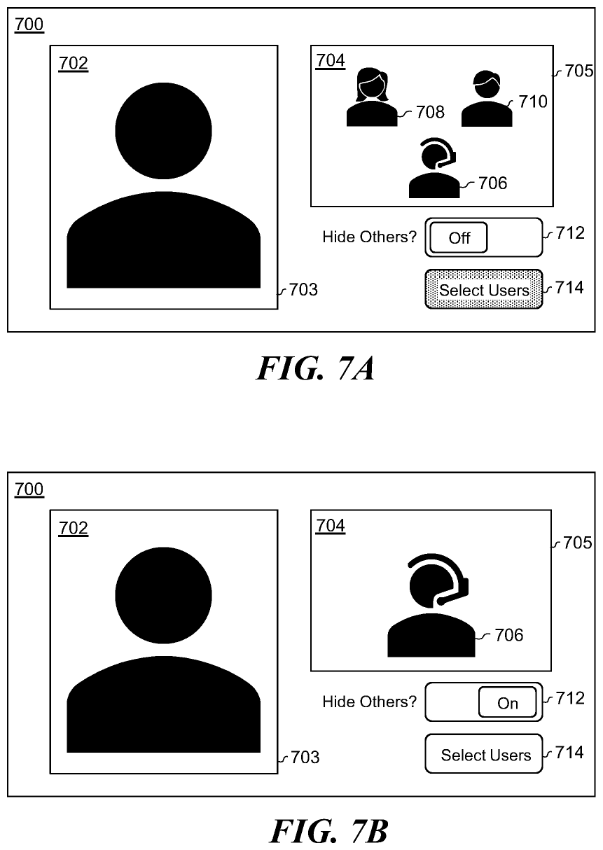

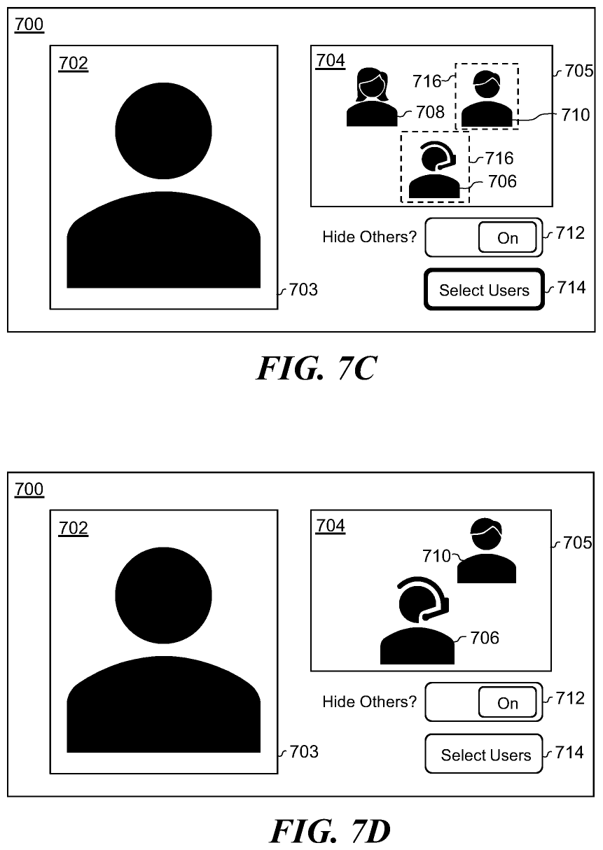

FIGS. 7A-7D show an illustrative UI 700 that can be provided within a client, according to some embodiments. For example, one or more portions of UI 700 may be implemented within meeting application 620 and/or video filter module 621 of FIG. 6. The illustrative UI 700 includes a first window 703 to display a video stream 702 received from a remote client and a second window 705 to display a video stream 704 generated and shared by the local client (i.e., the client on which UI 700 is displayed). In the example of FIGS. 7A-7D, a camera connected to the local client has three persons within its field of view: a first person 706 who may automatically identified as the current user of the local client using image recognition, a second person 708, and a third person 710. UI 700 further includes a toggle switch (“Hide Others”) 712 to selectively prevent certain persons from appearing within the shared video stream 704. In other words, toggle switch 712 can be used to selectively enable filtering of the shared video stream 704 using the structures and techniques disclosed herein. In more detail, toggle switch 712 can be used to switch between a first mode where all persons within the camera's field of view appear within the shared video stream 704 and a second mode where certain persons do not appear within the shared video stream 704. UI 700 further also includes a button (“Select Users”) 714 that may be used to select which persons are to appear when filtering is enabled.

As illustrated in FIG. 7A, when toggle switch 712 is off (i.e., filtering is disabled), all persons 706, 708, 710 within the camera's field of view may appear in the shared video stream 704. As also illustrated in FIG. 7B, button 714 may be disabled when filtering is disabled.

As illustrated in FIG. 7B, when toggle switch 712 is on (i.e., filtering is enabled), only the first person 706 identified as the current user of the local client may appear within the shared video stream 704. That is, persons 708 and 710 may be removed (e.g., automatically removed) from or otherwise prevented from appearing in the shared video stream 704 using the structures and techniques disclosed herein. As also illustrated in FIG. 7B, button 714 may be enabled when filtering is enabled.

As illustrated in FIG. 7C, after clicking/tapping button 714, the user can be provided with a selection tool for drawing rectangles 716 or other types of polygons around persons appearing within the second window 705. Various other types of controls may be used for selecting users to appear within the shared video stream 704. The user can select a single person, multiple persons, or no persons appearing in the second window 705. In the example of FIG. 7C, first person 706 and the third person 710 are shown as being selected. In response to the user selecting persons 706, 710 within the second window 705, the shared video stream 704 generated by the local client may be altered to hide the appearance of second person 708, as illustrated in FIG. 7D. With the appearance of second person 708 removed, the shared video stream 704 may be clipped, causing persons 706 and 710 to appear larger within the shared video stream 704.

The illustrative UI 700 as described above may utilized with a client that captures a video stream using a camera and transmits the video stream (or a filtered version thereof) to other clients. As described above, the transmitting client may perform the filtering that is response to different user inputs at the transmitting client. In other embodiments, the video filtering may be performed by the receiving clients responsive to user inputs at the transmitting client. For example, in the transmitting client can send the captured/unmodified video stream to the receiving clients along with information regarding the state of the UI 700, and the receiving clients can use the received configuration settings to filter the received video stream. In more detail, the transmitting client can, for example, send information indicating whether filtering is enabled based on the state of toggle switch 712 and information about which persons are selected based on selections made using rectangles 716.

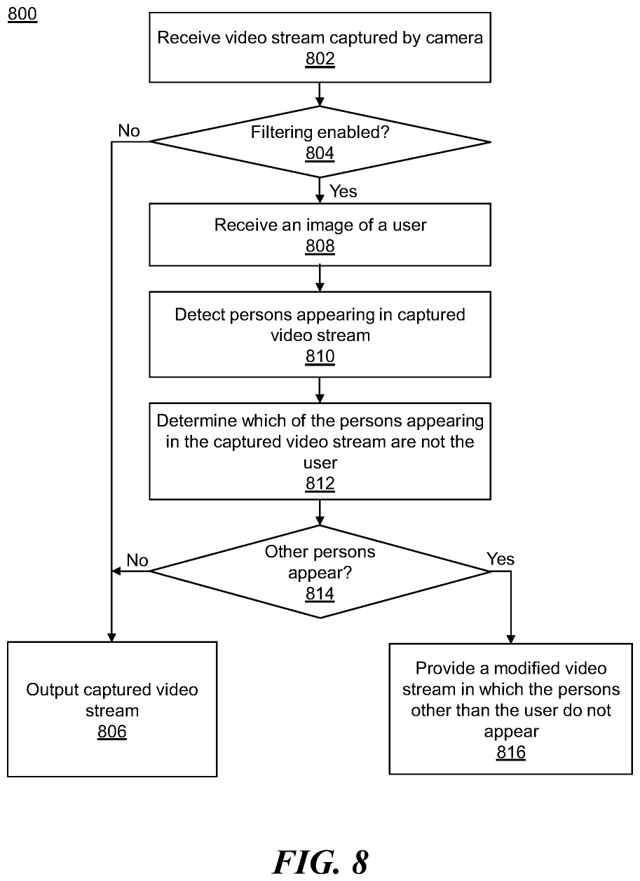

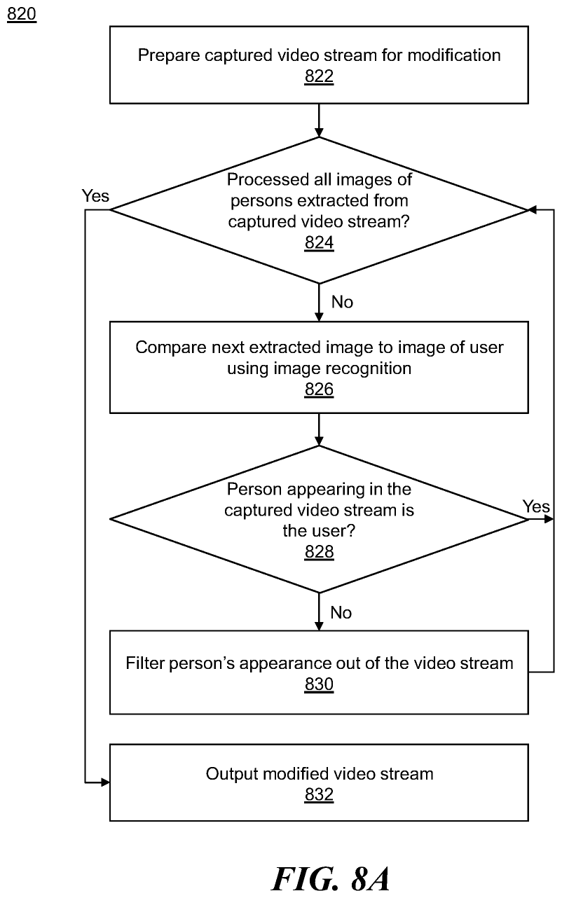

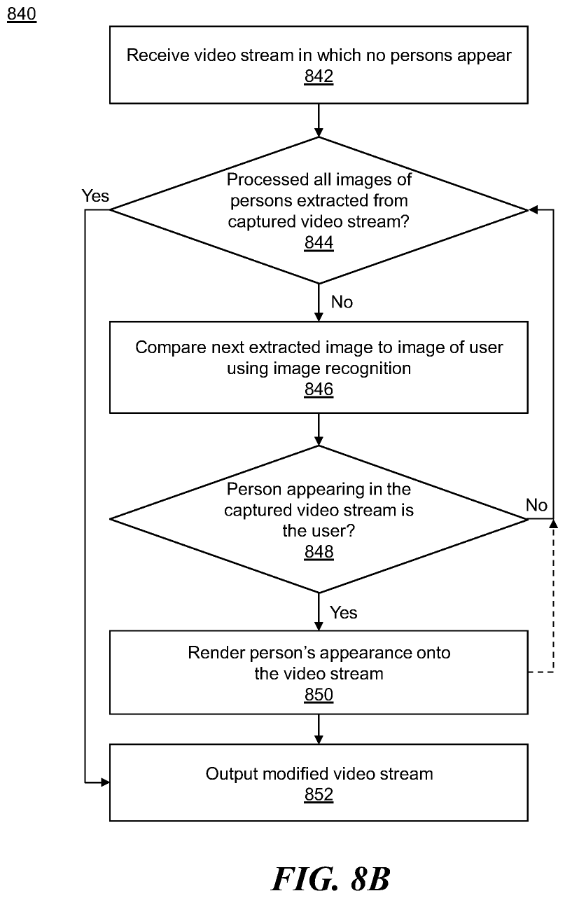

FIGS. 8, 8A, and 8B show examples of processes that can be used to conduct online meetings using image recognition, according to some embodiments. The illustrative processing may be implemented by a computing device associated with a user, such as client 600 of FIG. 6. In some embodiments, at least a portion of the processing of FIGS. 8, 8A, and 8B may be implemented within a server device.

Turning to FIG. 8, an illustrative process 800 can begin at block 802 by receiving a video stream captured by a camera. At block 804, a determination can be made whether filtering is enabled by the computing device. For example, block 804 may determine whether filtering is enabled based on the state of a UI control, such as toggle switch 712 of FIGS. 7A-7D. If filtering is disabled, then process 800 may output the captured video stream (e.g., transmit the captured video stream to one or more other computing devices at block 806 and/or display the captured video stream). If filter is enabled, then processing may proceed to block 808.

At block 808, an image or other data representative of the user's appearance may be received. For example, a profile image for the user may be retrieved from an OS of the computing device, from an application installed on the computing device, or from an external application or service. As another example, the user may select an image of themselves on screen using a selection tool, such as illustrated in FIG. 7C.

At block 810, one or more persons appearing in the captured video stream may be detected. For example, an object detection technique can be used to determine the presence and position of the persons within the video stream, and then image data at those corresponding positions may be extracted from the video stream. In some embodiments, a machine learning (ML)-based object detection technique may be used to detect the positions of persons appearing with the video stream and/or particular frames thereof. For example, a convolutional neural network (CNN) trained to detect the appearances of human bodies, human faces, etc. within images may be used at block 810.

At block 812, a determination can be made as to which of the persons appearing in the video are not the user. In some embodiments, one or more image recognition techniques can be used to match the image of the user (from block 808) to the extracted images of all persons appearing in the video stream (from block 810) and, thus, determine which persons appearing in the video steam are not the user. This determination can be probabilistic and based on which of the extracted images most closely matches the image of the user. If, at block 814, no persons other than the user appear in the captured video stream, then the captured video stream may be output (e.g., transmitted and/or displayed), at block 806. Otherwise, processing may proceed to block 816.

At block 816, a modified video stream can be provided in which the persons other than the user do not appear (i.e., do not appear when the modified video stream is played back or otherwise displayed). Various techniques for providing such a modified video stream are described above, for example, in the context of FIGS. 4A-4D. In some embodiments, the modified video stream may be transmitted to one or more other computing devices. In some embodiments, the modified video stream may be displayed by the computing device performing process 800. In some embodiments, the person detection of block 810, the person identification of block 812, and/or the video modification of block 816 may be implemented and performed by an online meeting service (e.g., meeting service 504 of FIG. 5) and/or within a cloud network (e.g., within cloud network 304 of FIG. 3).

FIGS. 8A and 8B show examples of processes for providing a modified video stream in which persons other than a user of a computing device do not appear. In some embodiments, the processing of FIGS. 8A and 8B may be performed, in whole or in part, as part of blocks 812 and 816 of FIG. 8.

Turning to FIG. 8A, a process 820 may be begin at block 822 by preparing a video stream captured by a camera for modification. In some embodiments, this can include generating a copy of the captured video stream. In other embodiments, the captured video stream may be directed modified and, thus, block 822 may perform steps to allow for such direct modification or, in some cases, block 822 be omitted/skipped. Process 820 may then iterate over one or more images of persons extracted from the captured video stream until all images have been processed, as indicated by decision block 824. In particular, at block 826, extracted images can be compared to an image of the user (or images of multiple users) using one or more image recognition techniques (e.g., facial recognition). At block 828, based on this comparison, it can be determined if the person appearing in the captured video stream is the user (or one of the multiple users). In some embodiments, this determination may be based on confidence threshold/interval. If it is determined that the person appearing in the captured video stream is not the user (or one of the multiple users), then the person's appearance may be filtered out of the video stream (e.g., removed, replaced, obfuscated, etc.) at block 830. If, at block 824, all the images of persons extracted from the captured video stream have been processed, then the modified video stream may be output/returned at block 832.

Turning to FIG. 8B, a process 840 may be begin at block 842 by receiving a video stream in which no users appear. For example, this may include generating a new video stream as an image (i.e., a video that when played back appears to be a static or other type of image). As another example, this may include copying the video stream captured by the camera and then removing any persons form the video stream. Process 840 may then iterate over one or more images of persons extracted from the captured video stream until all of the images have been processed, as indicated by decision block 844. In particular, at block 846, extracted images can be compared to an image of the user using one or more image recognition techniques (e.g., facial recognition). In some embodiments, the extracted images can be compared to images of multiple users (e.g., multiple meeting participants). At block 848, based on this comparison, it can be determined if the person appearing in the captured video stream is, or likely is, the user (or one of the multiple users). If so, then the person's appearance may be rendered onto the video stream. In some embodiments, the modified video stream may then be output/returned at block 852 (i.e., process 840 may terminate after a single user has been rendered onto the video stream). In other embodiments, the process may repeat from block 844 as indicated by the dashed line in FIG. 8B such that multiple users (e.g., multiple meeting participants) may be rendered onto the video stream. If, at block 848, the person appearing in the video stream is not the user (or not one of the multiple users), the process may repeat from block 844.

The following examples pertain to further embodiments, from which numerous permutations and configurations will be apparent.

Example 1 includes a method including: receiving, by a computing device associated with a user, a video stream captured by a camera; detecting, by the computing device, persons appearing within a field of view of the camera based on analysis of the video stream; and in response to a determination that one or more persons other than the user appear within the field of view of the camera, providing, by the computing device, a modified video stream in which the one or more persons other than the user do not appear during display of the modified video stream.

Example 2 includes the subject matter of Example 1, wherein the providing of the modified video stream includes removing appearances of the one or more persons other than the user from the video stream or from a copy of the video stream.

Example 3 includes the subject matter of Examples 1 or 2, wherein the providing of the modified video stream includes obfuscating appearances of the one or more persons other than the user within the video stream or within a copy of the video stream.

Example 4 includes the subject matter of any of Examples 1 to 3, wherein the providing of the modified video stream includes generating another video stream.

Example 5 includes the subject matter of any of Examples 1 to 4, and further including: receiving, by the computing device, data representative of the user's appearance, wherein the determination that the one or more persons other than the user appear within the field of view of the camera is based on the data representative of the user's appearance.

Example 6 includes the subject matter of Example 5, wherein the receiving of the data representative of the user's appearance includes receiving an image of the user.

Example 7 includes the subject matter of Example 6, wherein the image of the user is received from an application running on another computing device.

Example 8 includes the subject matter of Example 5, wherein the receiving of the data representative of the user's appearance includes receiving an image selected by the user.

Example 9 includes the subject matter of any of Examples 1 to 8, wherein the video stream is received from a first client device, and further including: transmitting, by the computing device, the modified video stream to a second client device.

Example 10 includes the subject matter of any of Examples 1 to 9, wherein the camera is in communication with the computing device, and further including: transmitting, by the computing device, the modified video stream to another computing device.

Example 11 includes a computing device including a processor and a non-volatile memory storing computer program code that when executed on the processor causes the processor to execute a process including: receiving a video stream captured by a camera; detecting persons appearing within a field of view of the camera based on analysis of the video stream; and in response to a determination that one or more persons other than a user associated with the computing device appear within the field of view of the camera, providing a modified video stream in which the one or more persons other than the user do not appear during display of the modified video stream.

Example 12 includes the subject matter of Example 11, wherein the providing of the modified video stream includes removing appearances of the one or more persons other than the user from the video stream or from a copy of the video stream.

Example 13 includes the subject matter of Example 11 or 12, wherein the providing of the modified video stream includes obfuscating appearances of the one or more persons other than the user within the video stream or within a copy of the video stream.

Example 14 includes the subject matter of any of Examples 11 or 13, wherein the providing of the modified video stream includes generating another video stream as an image.

Example 15 includes the subject matter of any of Examples 11 or 14, and further including: receiving data representative of the user's appearance, wherein the determination that the one or more persons other than the user appear within the field of view of the camera is based on the data representative of the user's appearance.

Example 16 includes the subject matter of Example 15, wherein the receiving of the data representative of the user's appearance includes receiving a profile image of the user.

Example 17 includes the subject matter of Example 16, wherein the profile image of the user is received from an application running on another computing device.

Example 18 includes the subject matter of Example 15, wherein the receiving of the data representative of the user's appearance includes receiving an image selected by the user.

Example 19 includes the subject matter of any of Examples 11 to 18, wherein the video stream is received from a first client device, and further including: transmitting the modified video stream to a second client device.

Example 20 includes a non-transitory machine-readable medium encoding instructions that when executed by one or more processors cause a process to be carried out, the process comprising: receiving, by a computing device associated with a user, a video stream captured by a camera; detecting, by the computing device, persons appearing within a field of view of the camera based on analysis of the video stream; and in response to a determination that one or more persons other than the user appear within the field of view of the camera, providing, by the computing device, a modified video stream in which the one or more persons other than the user do not appear during display of the modified video stream.

Example 21 includes the subject matter of Example 20, wherein the providing of the modified video stream includes removing appearances of the one or more persons other than the user from the video stream or from a copy of the video stream.

Example 22 includes the subject matter of Examples 20 or 21, wherein the providing of the modified video stream includes obfuscating appearances of the one or more persons other than the user within the video stream or within a copy of the video stream.

Example 23 includes the subject matter of any of Examples 20 to 22, wherein the providing of the modified video stream includes generating another video stream.

Example 24 includes the subject matter of any of Examples 20 to 23, and further including: receiving, by the computing device, data representative of the user's appearance, wherein the determination that the one or more persons other than the user appear within the field of view of the camera is based on the data representative of the user's appearance.

Example 25 includes the subject matter of Example 24, wherein the receiving of the data representative of the user's appearance includes receiving an image of the user.

Example 26 includes the subject matter of Example 25, wherein the image of the user is received from an application running on another computing device.

Example 27 includes the subject matter of Example 24, wherein the receiving of the data representative of the user's appearance includes receiving an image selected by the user.

Example 28 includes the subject matter of any of Examples 20 to 27, wherein the video stream is received from a first client device, and further including: transmitting, by the computing device, the modified video stream to a second client device.

Example 29 includes the subject matter of any of Examples 20 to 28, wherein the camera is in communication with the computing device, and further including: transmitting, by the computing device, the modified video stream to another computing device.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, by a computing device associated with a user, a video stream captured by a camera;
detecting, by the computing device, persons appearing within a field of view of the camera based on analysis of the video stream; and
in response to a determination that one or more persons other than the user appear within the field of view of the camera:
providing, by the computing device, a modified video stream in which the one or more persons other than the user do not appear during display of the modified video stream.

2. The method of claim 1, wherein the providing of the modified video stream includes removing appearances of the one or more persons other than the user from the video stream or from a copy of the video stream.

3. The method of claim 1, wherein the providing of the modified video stream includes obfuscating appearances of the one or more persons other than the user within the video stream or within a copy of the video stream.

4. The method of claim 1, wherein the providing of the modified video stream includes generating another video stream.

5. The method of claim 1, further comprising:
receiving, by the computing device, data representative of the user's appearance,
wherein the determination that the one or more persons other than the user appear within the field of view of the camera is based on the data representative of the user's appearance.

6. The method of claim 5, wherein the receiving of the data representative of the user's appearance includes receiving an image of the user.

7. The method of claim 6, wherein the image of the user is received from an application running on another computing device.

8. The method of claim 5, wherein the receiving of the data representative of the user's appearance includes receiving an image selected by the user.

9. The method of claim 1, wherein the video stream is received from a first client device, the method further comprising:
transmitting, by the computing device, the modified video stream to a second client device.

10. The method of claim 1, wherein the camera is in communication with the computing device, the method further comprising:
transmitting, by the computing device, the modified video stream to another computing device.

11. A computing device comprising:
a processor; and
a non-volatile memory storing computer program code that when executed on the processor causes the processor to execute a process including:
receiving a video stream captured by a camera;
detecting persons appearing within a field of view of the camera based on analysis of the video stream; and
in response to a determination that one or more persons other than a user associated with the computing device appear within the field of view of the camera:
providing a modified video stream in which the one or more persons other than the user do not appear during display of the modified video stream.

12. The computing device of claim 11, wherein the providing of the modified video stream includes removing appearances of the one or more persons other than the user from the video stream or from a copy of the video stream.

13. The computing device of claim 11, wherein the providing of the modified video stream includes obfuscating appearances of the one or more persons other than the user within the video stream or within a copy of the video stream.

14. The computing device of claim 11, wherein the providing of the modified video stream includes generating another video stream as an image.

15. The computing device of claim 11, wherein the process further includes:
receiving data representative of the user's appearance,
wherein the determination that the one or more persons other than the user appear within the field of view of the camera is based on the data representative of the user's appearance.

16. The computing device of claim 15, wherein the receiving of the data representative of the user's appearance includes receiving a profile image of the user.

17. The computing device of claim 16, wherein the profile image of the user is received from an application running on another computing device.

18. The computing device of claim 15, wherein the receiving of the data representative of the user's appearance includes receiving an image selected by the user.

19. The computing device of claim 11, wherein the video stream is received from a first client device, the process further including:
transmitting the modified video stream to a second client device.

20. A non-transitory machine-readable medium encoding instructions that when executed by one or more processors cause a process to be carried out, the process comprising:
receiving, by a computing device associated with a user, a video stream captured by a camera;
detecting, by the computing device, persons appearing within a field of view of the camera based on analysis of the video stream; and
in response to a determination that one or more persons other than the user appear within the field of view of the camera:
providing, by the computing device, a modified video stream in which the one or more persons other than the user do not appear during display of the modified video stream.
